(19) United States
(12) Patent Application Publication
(10) Pub. No.: US 2005/0254099 A1
(43) Pub. Date: Nov. 17, 2005

(54) Method, apparatus, and program for recording images

(75) Inventors: Akira Yoda, Kanagawa-Ken (JP); Shuji Ono, Kanagawa-Ken (JP); Yukita Gotohda, Kanagawa-ken (JP)

Correspondence Address: BIRCH STEWART KOLASCH & BIRCH, PO BOX 747, FALLS CHURCH, VA, 22040-0747, US

(73) Assignee: Fuji Photo Film Co., Ltd., Minami-Ashigara-Shi (JP)

(21) Appl. No.: 11/106,535

(22) Filed: Apr. 15, 2005

(30) Foreign Application Priority Data
Apr. 15, 2004 (JP) 120217/2004

(51) Int. Cl. H04N 1/21; H04N 1/04; G03B 17/24; H04N 5/225

(52) U.S. Cl. 358/403; 348/96; 348/231.5; 348/231.3; 348/231.2; 396/310; 358/487

(57) ABSTRACT

From which recording medium image data sets have been obtained is enabled to be known, when image data sets are read out of recording media and recorded into a different recording medium. When recording image data sets, which have been read out of a recording medium, into a DVD-R, a unique ID of the DVD-R is added to the file names of the image data sets. When the image data sets are read out from the DVD-R to generate a new DVD-R, a unique ID of the new DVD-R is added to the file names of the image data sets.

### BACKGROUND OF THE INVENTION

1. Field of the Invention

The present invention relates to an image recording method and an image recording apparatus, for reading out images from a recording medium and recording the read out images in another recording medium. The present invention also relates to a program that causes a computer to execute the image recording method.

2. Description of the Related Art

Prints obtained from conventional silver salt film are currently being used in a variety of manners. Such uses of the prints include: checking how subjects are pictured therein; communicating with friends by showing them the prints; printing additional prints to send to acquaintances; enlarging the prints for display; and arranging the prints in a photo album. However, prints obtained from silver salt film accumulate in great numbers if they are not organized. In this case, it becomes difficult to find a desired print from among the great number of prints, to print additional prints or to utilize the print for other uses. Particularly in the case that a great number of prints are accumulated, the prints are often arranged at random, without consideration to the order of photography thereof. Therefore, organization of the prints becomes even more difficult.

If prints are organized on a regular basis, use thereof is facilitated. However, classifying accumulated prints according to photography dates or themes is extremely troublesome. Further, even if the prints are organized and arranged in a photo album, there is generally only one copy of the photo album. Therefore, it is difficult for a great number of people to appreciate the photographs within the album, or for people who are far away to appreciate the photographs.

If organization of prints is neglected, negative films accumulate in addition to the prints. In many cases, negative films are kept in an unsorted manner. Even if an effort is made to organize the negative films, they are often stored in boxes and bags without being classified. As a user (photographer) ages, they may have children and grandchildren, which causes the number of prints and negative films to increase further. Therefore, if organization of prints is neglected, an enormous amount of unsorted prints and negative films accumulate. It is extremely rare for prints and negative films to be discarded, because this would preclude further printing of the images pictured therein. Therefore, many households are troubled by methods of organization and storage space for prints and negative films.

Meanwhile, photo service systems have been proposed in, for example, Japanese Unexamined Patent Publication Nos. 10 (1998)-150538 and 10 (1998)-150541. In these systems, images are read out from negatives and prints by readout apparatuses, such as scanners, and the obtained image data sets are stored in recording media, such as CD-R's. The images may then be appreciated using reproduction apparatuses, such as personal computers, or output as prints according to requests by users. Further, a network photo service system having an image storage function has been proposed in Japanese Unexamined Patent Publication No. 11 (1999)-154218. In this system, image data sets are transmitted to an image storage server that stores image data sets via a network, such as the Internet. Then, the image data sets may be appreciated at terminals remote from the image storage server. In addition, various processes may be administered on the image data sets, such as ordering prints thereof, at the remote terminals.

However, in the above image storage systems, images are read out from negative films during a development/printing process. That is, image data sets are stored in units of rolls of film. Therefore, the correlation between rolls of film and users who requested storage of image data sets is troublesome. In addition, because images are simply read out from negative films and stored as data, the aforementioned enormous amount of unsorted negative films and prints are stored as an enormous number of unsorted image data sets. In this case, it becomes necessary for users to access the image storage server to organize the image data sets. However, the organization of image data sets is just as troublesome as organization of negative films and prints. Also, the user friendliness of the systems is extremely poor.

For this reason, a system that provides a so called photo mining service has been proposed, in U.S. patent application Publication No. 20030151767. In the photo mining system, image data sets are obtained from recording media, such as prints and images, on which images are recorded. The image data sets are correlated with recording media data that represents the recording media, from which the image data sets were obtained. Then, the image data sets, which are correlated with the recording media data, are stored in units of users, based on user data. If this system is employed, even if the enormous amount of negative films and prints, which have accumulated in households, are unsorted, users request readout of images at a DPE store. Therefore, the image data sets, which have been obtained by readout, can be referred to in a state in which they are organized, based on recording media data.

Incidentally, recording of the image data sets obtained by readout onto recording media, such as DVD-R, for provision to users may be considered in the above system. At this time, it is possible to generate image data in a slide show format, from the image data sets, and to record the slide show image data along with the image data sets. Thereby, users are enabled to appreciate the slide show by using their DVD players, or by using terminal devices, such as personal computers.

Meanwhile, there are cases in which it is desired to give image data sets, which have been recorded in recording media, to other people. For example, if a child is getting married, it may be desired to give image data sets that represent images related to the child to the child. In these cases, users bring their recording media to a DPE store. The DPE store refers to comments and the like, which are attached to the image data sets, to read out image data sets that include the user's child's name in the comments. Then, the read out image data sets are compiled into image data in a slide show format, which is recorded in a new recording medium along with the image data sets.

By users repeatedly ordering the photo mining service, users will end up with a plurality of recording media. In these cases, the users bring the plurality of recording media to the DPE store. The DPE store reads out image data sets that have the child's name attached thereto as comments from each of the plurality of recording media, and record the read out image data sets into a single recording medium.

In cases such as that described above, in which image data sets are read out from recording media and recorded in a different recording medium, it is convenient if indications regarding which recording medium the image data sets were originally recorded in are provided.

### SUMMARY OF THE INVENTION

The present invention has been developed in view of the above circumstances, and it is an object of the present invention to enable recognition of which recording medium image data sets were originally recorded in, in the case that image data sets are read out from recording media and then recorded in a different recording medium.

The image recording apparatus of the present invention comprises:
image readout means, for reading out image data sets, which are recorded in a first recording medium identified by first unique identifying data, and which include the identifying data;
recording means, for recording the read out image data sets in a second recording medium identified by second unique identifying data; and
identifying data adding means, for adding the second unique identifying data to the image data sets in addition to the first unique identifying data, when recording the read out image data sets onto the second recording medium.

The “unique identifying data” may be numbers, symbols or combinations of the two, for identifying each recording medium.

Note that in the image recording apparatus of the present invention, the identifying data may be written in metadata, and the identifying data adding means may add the identifying data as metadata.

In addition, in the image recording apparatus of the present invention, additional data regarding the image data sets may be recorded in the first recording medium as metadata; and the recording means may record date data, that represents the date when recording is performed, in addition to the additional data when recording the image data sets in the second recording medium.

Further, in the image recording apparatus of the present invention, the unique identifying data may be included in file names; and the identifying data adding means may add the unique identifying data to the file names.

The image recording method of the present invention comprises the steps of:
reading out image data sets, which are recorded in a first recording medium identified by first unique identifying data, and which include the identifying data;
adding second unique identifying data to the image data sets in addition to the first unique identifying data, when recording the read out image data sets onto a second recording medium identified by the second unique identifying data; and
recording the image data sets, having the identifying data of the second recording medium added thereto, in the second recording medium.

Note that the image recording method of the present invention may be provided as a program that causes a computer to execute the method.

The program of the present invention may be provided being recorded on a computer readable medium. Those who are skilled in the art would know that computer readable media are not limited to any specific type of device, and include, but are not limited to: floppy disks, CD's, RAM's, ROM's, hard disks, magnetic tapes, and internet downloads, in which computer instructions can be store and/or transmitted. Transmission of the computer instructions through a network or through wireless transmission means is also within the scope of this invention. Additionally, computer instructions include, but are not limited to: source, object, and executable code, and can be in any language, including higher level languages, assembly language, and machine language.

According to the present invention, image data sets, which include the identifying data of the first recording medium, are read out from the first recording medium. Then, the identifying data of the second recording medium is added to the image data sets in addition to the first unique identifying data, and the image data sets, which have the second identifying data added thereto, are recorded in the second recording medium. Therefore, which recording medium image data sets were originally recorded in can be easily known, by referring to the identifying data added to the image data sets, which are recorded in the second recording medium. Even if the second recording medium is to be employed as a recording medium, from which image data sets are read out to be recorded in other recording media, which recording media the image data sets have been recorded in, along with the recording medium that the image data sets are currently recorded in, can be easily known, by referring to the identifying data added to the image data sets.

### BRIEF DESCRIPTION OF THE DRAWINGS

FIG. 1 is a schematic diagram illustrating the construction of a photo mining system, to which the image recording apparatus of the present invention has been applied.

FIG. 2 is a block diagram that illustrates the schematic construction of an image forming apparatus.

FIG. 3 illustrates an example of the contents of a meta data file.

FIG. 4 is a diagram illustrating the directory structure of image data sets and DVD-Video files, which are recorded in a DVD-R.

FIG. 5 is a sectional view illustrating the construction of a DVD-R, which is utilized in the present embodiment.

FIG. 6 is a plan view illustrating the construction of an alternate DVD-R, which is utilized in the present embodiment.

FIG. 7 is a diagram for explaining a state in which images, whose orientations are unchanged, and an image, whose orientation is changed to portrait orientation, are continuously reproduced.

FIG. 8 is a diagram for explaining links between DVD-Video files.

FIG. 9 is a diagram for explaining writing into meta data files.

FIG. 10 is a diagram for explaining the setting of compression rates according to the evaluations of image data sets.

FIG. 11 is a diagram for explaining differences in display times based on the evaluations, during reproduction of a DVD-Video file.

FIG. 12 is a diagram for explaining lenticular synthesis of three images.

FIG. 13 is a diagram that illustrates the state in which strip regions of an image are provided adjacent to strip regions of another image during lenticular synthesis.

FIG. 14 is a schematic block diagram that illustrates an example of a DVD generating section.

### DESCRIPTION OF THE PREFERRED EMBODIMENTS

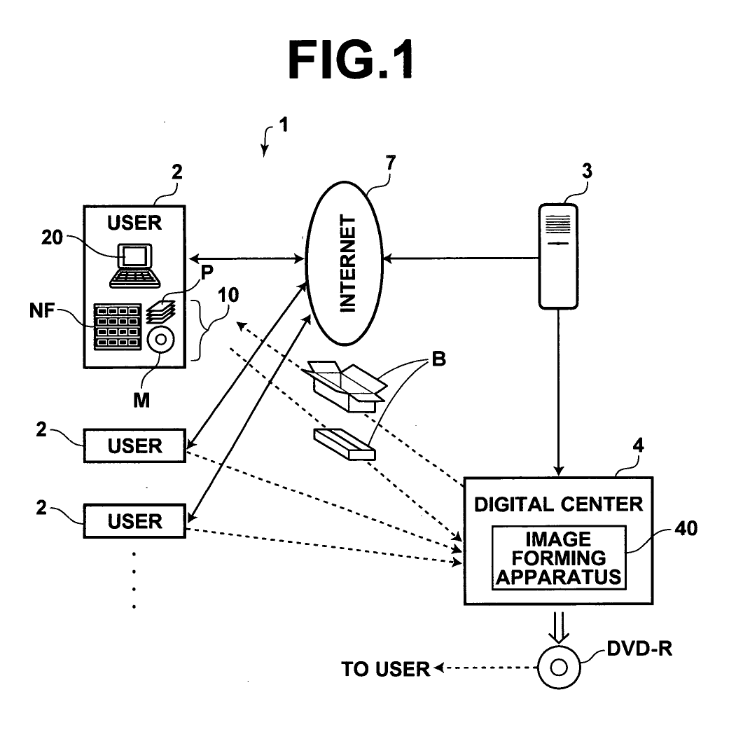

Hereinafter, an embodiment of the present invention will be described with reference to the attached drawings. FIG. 1 is a schematic diagram illustrating the construction of a photo mining system 1, to which the image recording apparatus of the present invention has been applied. As illustrated in FIG. 1, the photo mining system 1 receives and delivers various types of data, negative films, and prints, among a plurality of users 2, a photo mining server 3 (hereinafter, simply referred to as “PM server”), and a digital center 4. The PM server 3 receives orders for the photo mining service from the users 2 via the Internet 7. The digital center 4 processes orders for the photo mining services requested by the users 2.

Note that in the present embodiment, the photo mining service is that in which: image data sets S0 are obtained from users' negative films NF, prints P, or media M, such as CD-R's and memory cards; the obtained image data sets and a DVD-Video file in slide show format, generated from the image data sets, are recorded in media, such as DVD-R's; and the DVD-R's are delivered to the users.

The users 2 have an enormous amount of unsorted negative films NF and prints P, or a great number of unsorted image data sets recorded in media M. The users 2 request the photo mining service regarding the enormous amount of negative films NF and the prints P. That is, the users 2 have user terminals 20, such as personal computers, which are connected to the Internet 7. The users 2 use the user terminals 2 to access the PM server 3 and to request the photo mining service.

Note that the photo mining system 1 of the present embodiment provides services to registered users. The users 2 register as users at the PM server 3 in advance, and receive user ID's and passwords therefrom. Note that the users 2 register information, such as their names, their addresses, their ages, their telephone numbers, their e-mail addresses, and their family structures, as user information, during user registration. The registered user information is registered in a user information database of the PM server 3 and the digital center 4, as will be described later.

The PM server 3 operates a website for receiving orders for the photo mining service, and receives orders for the photo mining service from the users 2 thereat. At this time, the users 2 use the user terminals 20 to access the website of the PM server, input their user ID's and passwords and place an order for the photo mining service. The PM server 3 issues order numbers when orders are received from the users 2, and sends order confirmation e-mails that include the order numbers and a delivery date to the users 2. The PM server 3 also notifies the digital center 4 that orders have been received from the users 2. Note that this notification includes data that represents the user information, the order numbers, the delivery dates, and the order receipt date.

When notification that a user 2 has placed an order is received from the PM server 3, an operator at the digital center 4 refers to the user information included in the notification and the user information database. Then, the operator mails a delivery box B to the user 2. The delivery box B is for the user 2 to place their negative films NF, their prints P, and their media M (hereinafter, collectively referred to as “media 10”) in, and for mailing them to the digital center. Note that an order form, on which data, such as the user's order number, is recorded, is mailed to the user 2 as well. The order form may be pasted onto the delivery box B. Note that a bar code that corresponds to the order number is printed on the order form. The mailing of the delivery box B may alternatively be performed by an outside contractor, other than the digital center 4.

When the user 2 receives the delivery box B, they pack their media M in the delivery box B and mail it back to the digital center 4. At this time, the user 2 marks the order form to indicate the types of media 10, the number of media 10, and comments thereon.

When the digital center 4 receives the delivery box B, processes for the photo mining service are performed, employing an image forming apparatus 40.

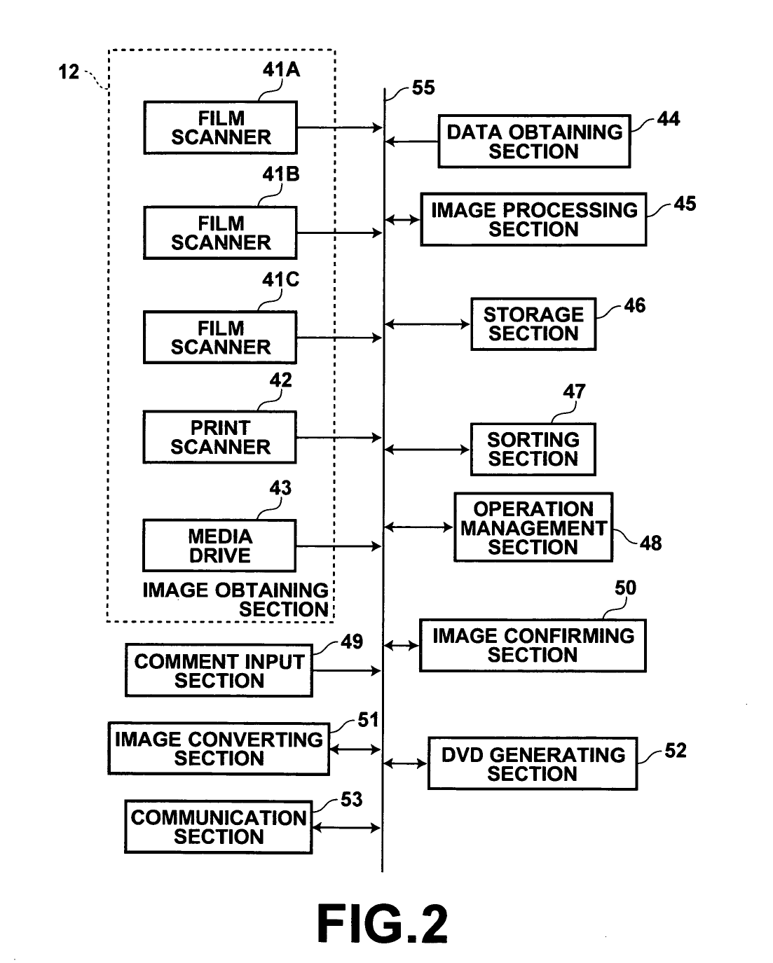

FIG. 2 is a block diagram that illustrates the schematic construction of the image forming apparatus 40. As illustrated in FIG. 2, the image forming apparatus obtains image data sets from the media 10, and generates DVD-R's, in which the obtained image data sets are recorded. The image forming apparatus 40 comprises: three film scanners 41A, 41B, and 41C; a print scanner 42; a media drive 43; a data obtaining section 44; an image processing section 45; and a storage section 46. The film scanners 41A, 41B, and 41C read out images, which are recorded on negative films NF, to obtain image data sets S0. The print scanner 42 reads out images, which are recorded on prints P, to obtain image data sets S0. The media drive 43 reads out image data sets S0 from the media M, to obtain image data sets S0. The data obtaining section 46 obtains information relating to photography dates (hereinafter, referred to as “photography date data D”) of the images recorded on the negative films NF and the prints P, and attaches this and other various types of data to the image data sets S0 obtained therefrom. The data obtaining section 44 also obtains photography date data D from the image data sets S0 read out from the media M, and attaches this and other various types of data to the image data sets S0 obtained therefrom. The image processing section 45 administers image processes and correction processes, such as red eye correction, on the image data sets S0, to obtain processed image data sets S1. The storage section 45 stores various types of data, including the image data sets S1, therein.

The image forming apparatus 40 further comprises: a sorting section 47; an operation management section 48; a comment input section 49; an image confirming section 50; an image converting section 51; a DVD generating section 52; and a communication section 53. The sorting section 47 sorts the media 10, mailed by the user 2, so that image data sets S0 are obtained from the media 10 by one of the film scanners 41A through 41C, the print scanner 42, and the media drive 43 (hereinafter, collectively referred to as “image obtaining section 12“). The operation management section 48 keeps track of which component of the image obtaining section 12 obtains image data sets S0 from each of the media 10, per each image data set obtainment process (hereinafter, referred to as “job”). The comment input section 49 receives comments related to the images in units of jobs or images. The image confirming section 50 confirms and corrects images represented by the processed image data sets S1. The image converting section 51 converts the image data sets S1 into image data sets S2 in Exif format, by attaching various types of data, such as the comments, to the image data sets S1. The DVD generating section 52 generates a DVD-Video file V0 in a slide show format from the image data sets S2, and generates DVD-R's, in which the image data sets S2 and the DVD-Video file V0 are recorded. The communication section 53 communicates with the PM server 3.

Note that the structural elements of the image forming apparatus 40 are connected by a bus 55.

The film scanners 41A, 41B, and 41C sequentially read out a plurality of images from the negative films NF, and obtains a plurality of image data sets S0 that represent the images recorded on the negative films NF.

The print scanner 42 reads out images from the prints P, and obtains image data sets S0 that represent the images recorded on the prints P.

The media drive 43 obtains image data sets S0, by reading out image data sets S0, which are recorded in the media M. Note that because there are a great many types of media M, a media drive 43 that corresponds to media which are commercially available is utilized.

The data obtaining section 44 obtains the photography date data D from the negative films NF and the prints P. Code numbers (hereinafter, referred to as “DX codes”), which are specific to films, are recorded on the negative films NF. By referring to the DX codes, it is possible to estimate the year that the film was produced. For this reason, the data obtaining section 44 reads out the DX codes, which are recorded on the negative films NF, and refers to a year database, which is stored in the storage section 46, to obtain photography date data D that represents the year that the negative films NF were poduced.

Note that in the case that the negative films NF are so called APS film having magnetic recording portions, in which magnetic information is recordable, photography dates may be recorded as magnetic information in the magnetic recording portions. In this case, the magnetic information, which is recorded in the magnetic recording portion and represents the photography dates, may be read out as the photography date data D.

In addition, in the case that dates are pictured within images, the photography dates can be known by reading out the dates and performing character recognition. In this case, the data obtained by reading out the dates pictured in the images may be employed as the photography date data D. Note that there are images, from which the dates pictured therein are difficult to read. In these cases, the photography date data D for these images may be obtained, based on dates read out from preceding and following images.

Regarding the prints P, in the case that dates are pictured in the prints P, the photography dates may be obtained by reading out the dates and performing character recognition. The photography dates obtained in this manner may be employed as the photography date data D.

In the case that the prints P have borders, there are cases in which information indicating the year that the prints were produced, such as “Fujicolor 99”, is written in the borders. There are also cases in which information indicating the year that the prints were produced (for example, a brand logo that changes according to the year of sale) is printed on the rear surface of the prints P. In these cases, readout is performed on the borders or the rear surfaces of the prints P, then character recognition is performed, to obtain information which may be employed as the photography date data D.

Note that there are cases in which users 2 write photography dates on film housing sheets for the negative films NF, bags containing the film housing sheets, and/or the rear surfaces of the prints P. Alternatively, users 2 may write the photography dates for each of the media 10 on the order form. In these cases, the operator at the digital center 4 inputs these dates as comments at the comment input section 4, and the input dates may be employed as the photography date data D.

The image data sets S0, which are read out from the media M, already have photography date information in the tags thereof. Therefore, the photography date data D may be obtained, based on the photography date information in the tags.

As described above, the photography date data D may be obtained, based on a variety of types of information sources, such as the DX codes, photography dates pictured in the images, photography dates specified by users, information written in the borders or on the rear surfaces of prints P, and information recorded in tag data. For this reason, it is preferable that the order of priority of the information sources is determined, and that the photography date data D is obtained according to the order of priority. It is also preferable that the information source, from which the photography date data D was obtained, is capable of being discriminated, to enable recognition of which information source the photography date data D was obtained. Note that a plurality of photography date data D may be obtained for a single image, correlated to the information source, without prioritizing the information sources.

Further, the data obtaining section 44 obtains various types of other data, such as frame numbers of images read out from the negative films NF, and the type of media from which an image data set S0 was read out (negative film NF, print P, or media M). The various types of data are combined with the photography date data D, to constitute data to be attached to the image data sets S0.

Note that the photography date data D may be obtained by the data obtaining section 44 simultaneously with obtainment of the image data sets S0 by the image obtaining section 12. In this case, the data obtaining section 44 is built in to the image obtaining section 12, and an operator of the image obtaining section 12 operates the data obtaining section 44 as well.

The image processing section 45 administers image processes for improving image quality, such as gradation processes, color conversion processes, and sharpness processes, on the image data sets S0, to obtain processed image data sets S1.

The storage section 46 comprises a high capacity hard disk. The storage section 46 temporarily stores the image data sets S0 obtained by the film scanners 41A through 41C, the print scanner 42, and the media drive 43. The storage section 46 also temporarily stores the processed image data sets S1. The storage section 46 stores therein the year database, in which the relationships among DX codes on films and the production year thereof, and relationships among brand logos on prints and the production year thereof are recorded.

The data obtaining section 44 can obtain photography date data D that represents the year which a negative film NF was produced, by reading the DX code thereon and referring to the year database. The data obtaining section 44 can also obtain photography date data D that represents the year which a print P was produced, by reading the brand logo thereon and referring to the year database.

The sorting section 47 sorts the plurality of media 10, so that image data sets S0 are obtained from the media 10 by one of the components of the image obtaining section 12, according to commands from an operator.

The operation management section 48 manages the photo mining service performed by the digital center 4. That is, all of the operations of the photo mining service, such as: receiving orders; mailing the delivery box B; receiving the delivery box B; sorting; obtaining the image data sets S0; image processing; comment input; image confirmation; image conversion; DVD generation; DVD delivery; and billing, are managed per user, per order number, by employing an operation management database.

The comment input section 49 receives comments regarding the obtained image data sets. Names of events, written by the users 2 on film housing sheets for the negative films NF, on the rear surfaces of the prints P, or on the order forms, maybe employed as the comments.

The image confirming section 50 is for confirming the processed image data sets S1, on which image processes have been administered, and for correcting the processed image data sets S1.

The image converting section 51 converts the image data sets S1, for which image confirmation has been completed, into image data sets S2 in Exif format, by attaching data, which has been registered in the operation management database for each image, to the corresponding image data set S1 as tag data. At this time, image data sets S1, whose orientations require adjustments, are rotated then converted to the image data sets S2. In addition, the file name of the image data sets S2 are changed to that which includes an ID unique to the DVD-R, in which the image data sets S2 are to be recorded. For example, if the original file name of an image data set S2 is pm0001.jpg, and the unique ID of the DVD-R is U001, the file name of the image data set S2 is changed to pm0001_U001.jpg.

In addition, the image converting section 51 generates meta data files X0 corresponding to each image data set S2. The meta data files X0 are files in xml format, and are assigned file names that correspond to the image data sets S2. For example, if the file name of an image data set S2 is pm0001_U001.jpg, the file name of the corresponding meta data file X0 is meta0001_U001.xml.

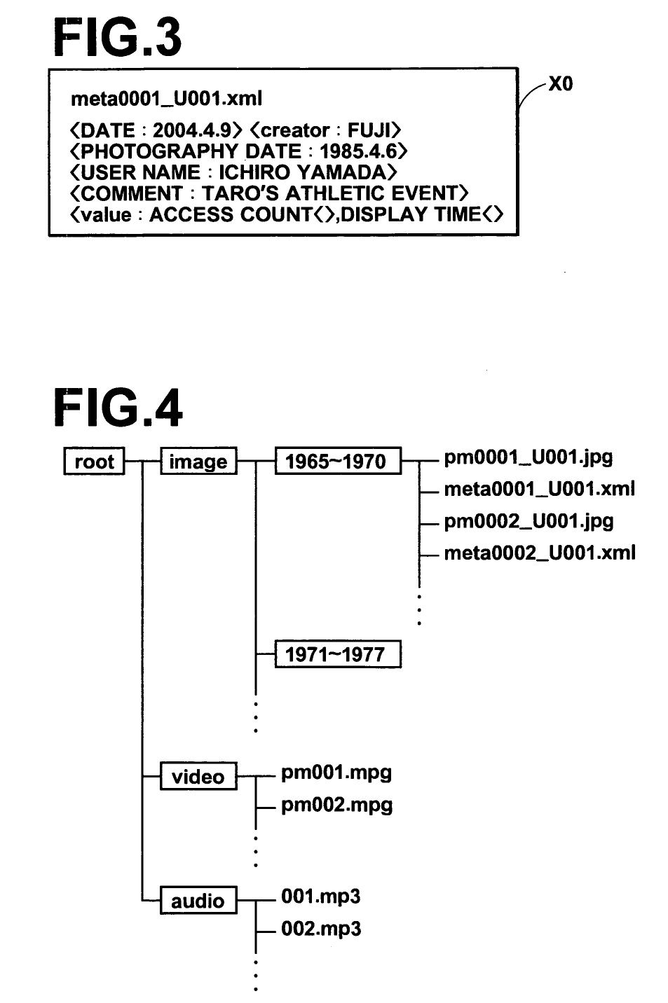

FIG. 3 illustrates an example of the contents of a meta data file X0. As illustrated in FIG. 3, the meta data file X0 describes: its file name; the date that the image data set S2 was generated; the name of a creator (in this case, FUJI, the photo mining service provider); the photography date represented by the photography date data D; the name of the user to whom the media 10, from which the image data set S2 was obtained, belongs; comments; and values regarding the image data set S2. Note that the values regarding the image data set S2 are written into the meta data file X0 as the user 2 uses the image data set S2, after the user 2 receives the DVD-R in which the image data set S2 is recorded. In addition, when the DVD-Video file V0, to be described later, is generated, the file name of background music to be utilized, effects that are applied during reproduction of a slide show, and the like are added to the meta data file X0.

Note that the meta data file X0 may be recorded as a single file that includes values for a plurality of image data sets. In this case, the unique ID of a single disk and the file names of the plurality of image data sets are written into the meta data file X0. An example of the contents of such a meta data file X0 is: <Unique Disk ID: U001>, <File Name: pm0001_U001.jpg>, <File Name: pm0002_U001.jpg> . . . Here, the unique ID of a disk is an identifier unique to a DVD-R to be generated. Note that in this case, the unique ID of the disk may be omitted from the file names of the image data sets. An example of the contents of such a meta data file X0 is: <Unique Disk ID: U001>, <File Name: pm0001.jpg>, <File Name: pm0002.jpg> . . .

The DVD generating section 52 records all of the image data sets S2 and the meta data files X0 generated by the image converting section 51 in a DVD-R. At this time, the DVD generating section 52 calculates the amount of unused capacity in the DVD-R. Then, DVD-Video files V0, of sizes appropriate for the amount of unused capacity, are generated and recorded in the DVD-R.

Specifically, the image data sets S2 are classified into a plurality of groups, according to the years in which they were photographed. Numbers of image data sets S2 that correspond to the amount of unused capacity are selected from each group. Files in MPEG format, in which images are continuously switched and displayed, are generated from the selected image data sets S2. Further, authoring is performed to include a title menu and BGM (background music), to generate a DVD-Video file V0.

Note that a reproduction order file that represents the order, in which the selected image data sets S2 are reproduced, may be generated. The reproduction order file maybe recorded in the DVD-R in a predetermined format. In this case, the slide show can be reproduced in the reproduction order described in the reproduction order file by a player, which is capable of reproducing the file in the predetermined format. An MPV format, in which the file names of image data sets which are to be reproduced and the reproduction times therefor are written in the reproduction order, may be employed as the predetermined format. According to this method, changes, deletions, and additions to the reproduction order can be effected, simply by editing the MPV file. Note that it is preferable that images, which are to be included in the DVD-Video file V0, are selected, in the case that the reproduction order file is generated.

It is also desirable for data (a file name, for example) regarding a representative image that represents the images included in the slide show to be recorded, corresponding to the reproduction order file. It is preferable for the data regarding the representative image to be written in the reproduction order file. In this case, the data regarding the representative image may be written, by adding a “representative mark” after the file name of the representative image, from among the file names of images, which are written in the reproduction order file. It is preferable that a plurality of representative marks are added to the file name of the representative image.

Various methods may be employed to select the representative image. Examples include: a method in which selection is based on value data of image data sets, written in the meta data thereof, as will be described later; and a method in which the photography periods of images to be reproduced in a slide show are divided, and selecting a representative image for each photography period.

FIG. 4 is a diagram illustrating the directory structure of the image data sets S2 and the DVD-Video files V0, which are recorded in a DVD-R. As illustrated in FIG. 4, an image folder, a video folder, and an audio folder are formed beneath the root directory. The image data sets S2, along with the meta data files X0, are recorded in the image folder. The DVD-Video files V0 are recorded in the video folder. Music files, to be played as background music during reproduction of the DVD-Video files V0, are recorded in the audio folder.

Folders corresponding to years of photography dates, into which the image data sets S2 are classified, are formed beneath the image folder. Each of these folders contain image data sets S2 having file names pm001_U001.jpg, pm0002_U001.jpg, . . . and meta data files X0 having file names meta0001_U001.xml, meta0001_U001.xml, . . .

Note that the meta data files X0 may be recorded, corresponding ot each image, as illustrated in FIG. 4, or a meta data file X0 may be generated for each folder that the images have been classified into. In this case, additional data regarding the images, which have been classified into the folders, such as: file names, photography date, value, title, and comments, are written into a single meta data file X0. By recording a single meta data file X0 for each folder, what kids of images are recorded in each folder can be understood easily, simply by referring to the meta data file X0. Further, in this case, data related to the entire image group, which is recorded in the folder, may be written as additional data. Examples of data related to the entire image group include: photography period data (the first photography date and the last photography date); the title of the image group, and the file name of the representative image that represents the image group.

The video folder contains DVD-Video files V0, having file names such as pm001.mpg, pm002.mpg, . . . Note that MPEG data files, which have been recorded by digital cameras and digital video cameras and which have been recorded in media M, are also recorded in the video folder. It is preferable that Index-Video files Vidx that correspond to the MPEG data files and to the DVD-Video files V0 are also recorded in the video folder. The Index-Video files Vidx may have file names such as pmIndex001.mpg, pmIndex002.mpg . . . The Index-Video files Vidx are generated by selecting representative frames from original DVD-Video files pm001.mpg, pm002.mpg . . . The Index-Video files Vidx may be displayed on a selection screen, when selecting a DVD-Video file V0 to be reproduced by a DVD player, for example.

The audio folder contains a plurality of music files. Users 2 are enabled to select a music file from among the plurality of music files, to be played as background music during reproduction of a DVD-Video file V0. The music files contained in the audio folder have file names such as 001.mp3, 002.mp3, . . .

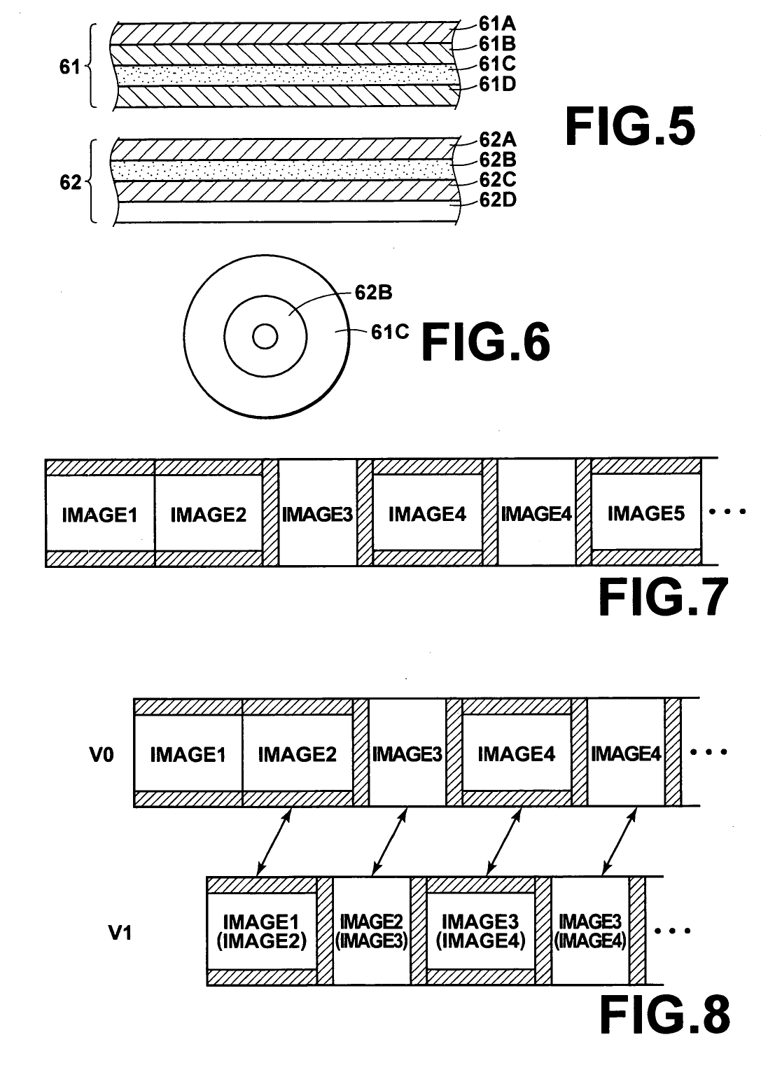

FIG. 5 is a sectional view illustrating the construction of a DVD-R, which is utilized in the present embodiment. As illustrated in FIG. 5, the DVD-R comprises a two layer structure, comprising a first recording layer 61 and a second recording layer 62. The first recording layer 61 comprises: a protective layer 61A; a first SiO₂ layer 61B; an organic pigment layer 61C; and a second SiO₂ layer 61D. Data is recorded by the organic pigment layer 61C being destroyed by laser light. The second recording layer 62 comprises: a first SiO₂ layer 62A; a phase change metallic layer 62B; a second SiO₂ layer 62C; and a polycarbonate substrate 62D. Data is recorded by a phase change phenomenon, in which the phase change metallic layer being heated by laser light, thereby causing changes in the crystal state thereof.

Here, the first recording layer 61, which is a deeper layer than the second recording layer 62, has a lower probability of being destroyed, and therefore it is safer. In addition, the organic pigment layer 61C is more durable than the phase change metallic layer 62B.

For this reason, data such as the image data sets S2, which would cause irreparable damage if lost, is recorded in the first recording layer 61 in the present embodiment. Data such as the meta data files X0, the DVD-Video files V0, and the music files, which can be regenerated even if lost, is recorded in the second recording layer 62. Note that the second recording layer 62 may be a rewritable recording layer.

Note that the DVD-R to be utilized in the present embodiment is not limited to that of the two layer structure described above. A DVD-R of a construction such as that illustrated in FIG. 6 may alternatively be employed. The DVD-R of FIG. 6 has the phase change metallic layer 62B of the second recording layer 62 at the radially outer portion thereof, and the organic pigment layer 61C of the first recording layer 61 at the radially inner portion thereof. This construction is adopted because the rotation speed of the radially inner portion of the DVD-R is lower than that of the radially outer portion, and there is a lower probability that writing errors will occur when recording data onto the radially inner portion.

During generation of the DVD-Video files V0, there are cases in which the correct orientations of images, represented by the image data sets S2 to be included in the DVD-Video files V0, are unclear. In these cases, the DVD-Video files V0 are generated such that the image data sets S2, of which the correct orientations are unclear, are reproduced in both landscape and portrait orientations within slide shows. FIG. 7 is a diagram for explaining a state in which images, whose orientations are unchanged, and an image, whose orientation is changed to portrait orientation, are continuously reproduced. In FIG. 7, image 4, which is the fourth image to be reproduced, is first reproduced with its orientation unchanged, then reproduced with its orientation changed to portrait orientation.

In this manner, images, of which the correct orientations are unclear, are continuously reproduced, first with their orientations unchanged, then with their orientations changed to portrait orientation. Thereby, users 2 can confirm which orientation is correct, for the images which are reproduced continuously in two orientations. Further, the users 2 may employ the user terminals 20 or DVD players having editing functions to edit the slide shows such that images that are displayed with incorrect orientations are skipped, and to save data that represents the skipped images. When the DVD-Video files V0 are reproduced again, the saved data is referred to, and the images that were skipped during the first reproduction of the slide shows are not displayed. Accordingly, slide shows, in which all of the images are displayed in their correct orientations, can be reproduced.

In addition to DVD-Video files V0 sorted by years, DVD-Video files V0 comprising image data sets S2 that have predetermined keywords, such as a child's name or “athletic event”, in their comments may be generated. For example, a DVD-Video file V1, comprising image data sets S2 that have “athletic event” in their comments may be generated. Then, images of athletic events, which are included in a DVD-Video file V0 sorted by date, may be linked to images within the DVD-Video file V1.

FIG. 8 is a diagram for explaining links between DVD-Video files. In FIG. 8, it is assumed that the second, third, and fourth images of a DVD-Video file V0 are images that include “athletic event” in their comments. It is also assumed that the first, second, and third images of a DVD-Video file V1 correspond to the second, third, and fourth images of the DVD-Video file V0. In this case, the second, third, and fourth images of the DVD-Video file V0 are linked to the first, second, and third images of the DVD-Video file V1, respectively.

When the DVD-Video file V0 is being reproduced and the second image is displayed, if a user 2 instructs the user terminal 20 or their DVD player to execute the link, the DVD-Video file V1 is reproduced from the first image thereof. Accordingly, if an image picturing an athletic event is displayed during reproduction of a slide show, it is possible to reproduce a slide show that includes only images of athletic events from that point.

Note that a representative image, from among the image data sets S2 recorded on a DVD-R, may be printed on the surface of the DVD-R. Alternatively, the unique ID of the DVD-R may be printed on the surface of the DVD-R.

The DVD-R's which are generated in this manner are mailed to users 2 who placed orders therefor.

The users 2 can enjoy the slide shows, by reproducing the DVD-Video files V0 recorded therein. In addition, the users 2 can display the image data sets S2 recorded in the DVD-R in a catalog format at their user terminals 20, or administer image processes on the image data sets S2 themselves, to enjoy the images.

Media, in which data that represents slide show sequences comprising various sample images and background music files is recorded, may be provided to the users 2. The sample images included in the slide show sequences may be interchangeable with the image data sets S2 recorded in the DVD-R's. Thereby, users 2 may enjoy various slide shows, by interchanging the images recorded in the DVD-R's with the sample images.

The users 2 have a dedicated viewer for the photo mining service installed in their user terminals 20. By employing the viewer, the users 2 are enabled to change the orientations of the image data sets S2 recorded in the DVD-R's, the background music of the DVD-Video files V0, other effects during reproduction of the DVD-Video files V0, and comments.

In addition, all of the meta data files X0 recorded in the DVD-R's may be copied onto the user terminals 20 when displaying the image data sets S2 with the viewer. When changes are made to the image data sets S2 as described above, the contents of the changes are written into the meta data files X0 corresponding to the changed image data sets S2.

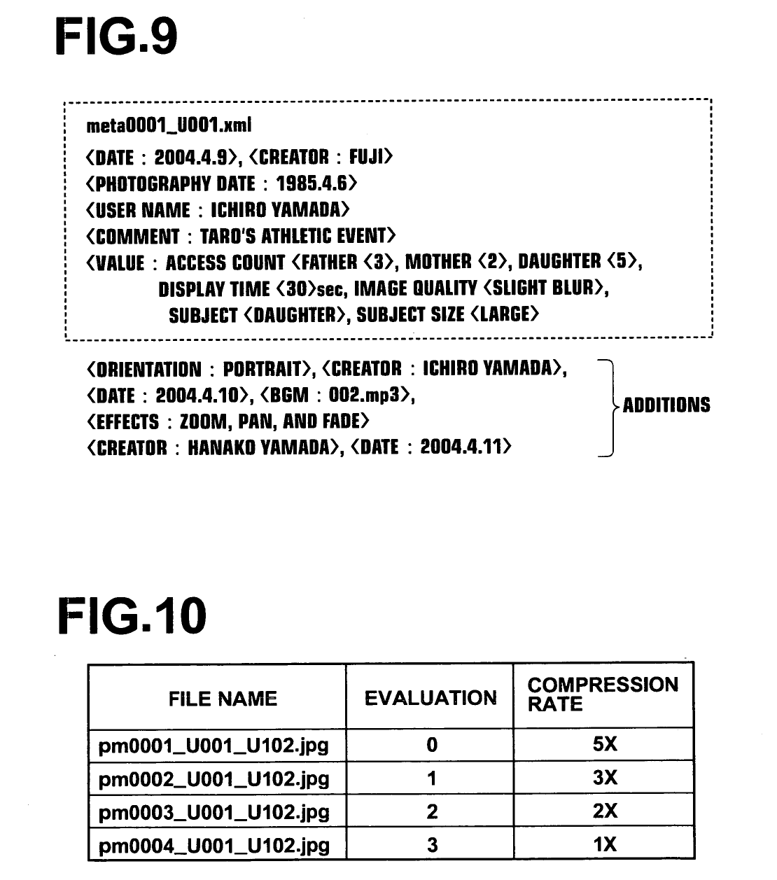

FIG. 9 is a diagram for explaining writing into the meta data files X0. The portion of FIG. 9 surrounded by the broken line indicates the original contents of a meta data file X0. In the case that the orientation of a image data set S2 corresponding to a meta data file X0 was incorrect, and therefore changed to a portrait orientation, new data “Orientation: Portrait” is added to the meta data file X0. In addition, data representing the creator of the new data and the date that the new data was created, “Creator: Ichiro Yamada” and “Date: 2004.4.10” are also added to the meta data file X0. In the case that the background music and visual effects for a DVD-Video file that includes the image data set S2 are changed, new data “BGM: 002.mp3” and “Effect: Zoom, Pan, and Fade” are added to the meta data file X0. In addition, data representing the creator of the new data and the date that the new data was created, “Creator: Hanako Yamada” and “Date: 2004.4.11” are added to the meta data file X0.

Note that the creator name may be the user name of the user 2 who logged in to the user terminal 20 to change the data. Alternatively, an accessing user name may be selected when the viewer is started up, and the selected accessing user name may be written as the creator name. At this time, images of the selectable accessing users' faces may be displayed along with the accessing user names at the selection screen.

Additional data is written into the Value fields of the meta data files X0 every time that a user 2 displays an image data set S2. Specifically, the number of times that the image data set S2 was displayed by the user 2, a total display time, image quality, the number of subjects within the image, and a desired subject size, are added. Here, the “number of times that the image data set S2 was displayed by the user 2” is counted according to the user name of the user 2 who logged in to the user terminal 20 to display the image data set S2, or according to the accessing user name, which was selected when the viewer was started up. The “display time” is the total amount of time that the image data set S2 was displayed by all users 2. In addition, the “image quality”, the “number of subjects”, and the “desired subject size” are added to the meta data file X0 by a user 2 inputting numerical values using the viewer software.

Meanwhile, there are cases in which it is desired to give the image data sets S2, which have been recorded in DVD-R's, to other people. For example, if a child of a user 2 is getting married, the user 2 may wish to give image data sets S2 that represent images related to the child, from among the image data sets S2, to the child. In addition, the user 2 may have repeatedly ordered the photo mining service, and may own a plurality of DVD-R's. In this case, the user 2 may wish to compile and record all of the image data sets S2 from all of the DVD-R's in a single DVD-R, or the user 2 may wish to give image data sets S2 related to their child, from among the image data sets S2 recorded in the plurality of DVD-R's, to their child. In the former case, the user 2 mails their DVD-R to the digital center 4 and order generation of a new DVD-R. The image forming apparatus 40 at the digital center 4 references the comments which are attached to the image data sets S2 and reads out image data sets S2 related to the user's child from the DVD-R's. The read out image data sets S2 and image data in slide show format are recorded in a new DVD-R. In the case that the user 2 owns a plurality of DVD-R's due to repeated ordering of the photo mining service, all of the DVD-R's may be mailed to the digital center 4 to order generation of a new DVD-R.

When new DVD-R's are generated in this manner, the users 2 deliver the meta data files X0, which have been added by use of the viewer, to the digital center 4, along with their DVD-R's. Specifically, the meta data files X0 may be transmitted to the digital center 4 from user terminals 20 via the Internet 7. Alternatively, the meta data files X0 may be recorded in a recording medium, such as a memory card provided to the users 2 as a part of the photo mining service, and mailed to the digital center 4. As a further alternative, in the case that the DVD-R's are of the rewritable type or have a rewritable recording region, the meta data files X0 may be written into the DVD-R's and mailed to the digital center 4. Note that the meta data files X0, which are delivered to the digital center 4, include the unique ID's of DVD-R's in their file names. Therefore, the correspondence among the meta data files X0 and DVD-R's is easily established.

Hereinafter, generation of a new DVD-R will be described. Generation of the new DVD-R is performed by the image forming apparatus 40. Note that in the following description, a case will be described in which a new DVD-R 102, in which images related to the daughter of a user 2 are recorded, is generated from image data sets S2, which are recorded in two DVD-R's 100 and 101 owned by the user 2.

First, the DVD generating section 52 selects image data sets (hereinafter, designated as image data sets S12), which include the word “daughter” or the name of the user's daughter in the comments, from among the image data sets S2 recorded in the DVD-R's 100 and 101. Then, evaluations of each of the selected image data sets S12 are calculated, based on the values written in the meta data files X0 corresponding thereto. Here, the number of times that the image data sets S12 have been displayed; the total display times; the image qualities; the types of subjects; and the subjects' sizes are written in the meta data files X0 as the values.

In the present embodiment, the DVD generating section 52 calculates evaluations Eval0 of the image data sets S12, according to the evaluation calculating function Formula (1) below.
Eval0=ax₁+bx₂+cx₃+dx₄+ex₅+fx₆ (1)
wherein a, b, c, d, e, and f are weighting coefficients;
x₁: number of times displayed (in this case, the number of times an image of the user's daughter has been displayed)
x₂: display time
x₃: amount of data included in the meta data file X0
x₄: image quality
x₅: number of subjects
x₆: subject size
   In Formula (1), the value of Eval0 increases as the number of times an image of the user's daughter has been displayed, the display time, the amount of data included in the meta data file X0, the image quality, the number of subjects, and the subject size increase. Therefore, the evaluations Eval0 reflect the preferences of the user's daughter, who is the subject of the DVD-R 102 to be newly generated.

The evaluations Eval0 calculated in this manner are added to the meta data files X0 corresponding to the image data sets S12, with the creator written as “FUJI”. Note that in the present embodiment, the evaluations Eval0 may be written in the meta data files X0 as values in four increments, such as 0, 1, 2, and 3, according to the range of the calculated evaluations Eval0.

Next, the image converting section changes the file names of the image data sets S12, by adding the unique ID of the new DVD-R 102, in which the image data sets S12 are to be recorded. For example, in the case that the unique ID of the new DVD-R 102 is U102, and the file name of an image data set S12 read out form the DVD-R 100 is pm0001_U001.jpg, the filename of the image data set S12 is changed to pm0001_U001_U102.jpg. In the case that the file name of an image data set S12 read out from the DVD-R 101 is pm0001_U002.jpg, the file name of the image data set S12 is changed to pm0001_U002_U102.jpg. Here, the image data sets S12 read out from the DVD-R's 100 and 101 include the unique ID's of the DVD-R's in their file names. Therefore, no redundant file names are created in the new DVD-R 102.

In addition, meta data files X0 are generated, corresponding to the image data sets S12. The meta data files X0 corresponding to the image data sets S12 are the meta data files X0 delivered to the digital center 4 by the users 2, to which data regarding the evaluations, file names of background music files to be utilized by a newly generated DVD-Video file V0, visual effects to be utilized during reproduction of slide shows, and the like, are added.

Alternatively, a single meta data file X0 may be generated for a plurality of images, which had been recorded in the same DVD-R. In this case, two unique disk ID's and the file names of the plurality of image files are written in the meta data file X0. An example of the contents of such a meta data file is: <Unique Disk ID: U001>, <Unique Disk ID: U002>, <File Name: pm0001_U001_U002> . . . Note that by storing images from different original disks into different directories, redundancy of file names within directories can be avoided. In this case, the portion of the file names that indicate the unique disk ID's can be omitted. An example of the contents of such a meta data file X0 is: <Unique Disk ID: U001>, <Unique Disk ID: U002>, <File Name: pm0001> . . .

In addition, if date data that represents the date that the image data sets have been recorded in the meta data files X0, when and from which CD-R the images have been copied can be easily understood.

The DVD generating section 52 classifies all of the image data sets S12, of which the image converting section 51 has changed the file names, into folders corresponding to years of photography dates, and records them into the new DVD-R 102. At the same time, the DVD generating section 52 calculates the amount of unused capacity in the DVD-R 102. Then, DVD-Video files V0, of sizes appropriate for the amount of unused capacity, are generated and recorded in the DVD-R 102.

If image data sets S12 picturing a user's daughter are read out from two DVD-R's 100 and 101 and recorded into a single DVD-R 102, there are cases in which the total amount of data of the image data sets S12 exceeds the data capacity of the DVD-R 102. In these cases, the present embodiment refers to the data regarding the evaluations of the image data sets S12, which are written in the meta data files X0 corresponding thereto. Then, the compression rates of the image data sets S12 are varied in a stepwise manner according to the evaluations Eval0. That is, the compression rate is set higher for image data sets S12 having low evaluations Eval0, thereby decreasing the amount of data therefor. The compression rates are set higher for image data sets S12 having low evaluations, because it is not a problem for the users 2 if the image qualities of these image data sets deteriorate, due to being compressed at higher compression rates.

FIG. 10 is a diagram for explaining the setting of compression rates according to the evaluations of the image data sets. As illustrated in FIG. 10, the evaluations of four image data sets S12 pm0001_U001_U002.jpg, pm0002_U001_U002.jpg, pm0003_U001_U002.jpg, and pm0004_U001_U002.jpg are 0, 1, 2, and 3, respectively. Therefore, the compression rates are varied to 5×, 3×, 2×, and 1×, respectively.

Note that image data sets S12 having evaluations of the lowest increment may alternatively not be recorded in the new DVD-R 102. Thereby, the total amount of data for the image data sets S12 can be reduced.

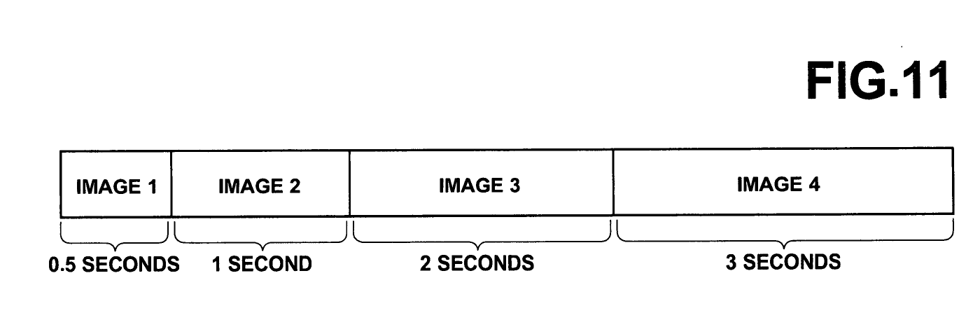

The DVD generating section 52 generates new DVD-Video files V0, comprising equal numbers of image data sets S12 selected from each folder, to be recorded in the new DVD-R 102. At this time, the DVD-Video files V0 are generated such that images represented by image data sets S12 having higher evaluations are displayed for longer periods of time, by referring to the evaluations written in the meta data files X0. For example, the possible evaluations in the present embodiment are in four increments of 0, 1, 2, and 3. The display times for images represented by image data sets S12 having evaluations of 0, 1, 2, and 3 are set at 0.5 seconds, 1 second, 2 seconds, and 4 seconds, respectively. FIG. 11 is a diagram for explaining differences in display times based on the evaluations, during reproduction of a DVD-Video file V0. Note that in FIG. 11, the aforementioned four image data sets S12 pm0001_U001_U002.jpg, pm0002_U001_U002.jpg, pm0003_U001_U002.jpg, and pm0004_U001_U002.jpg are illustrated as image 1, image 2, image 3, and image 4, respectively. The DVD generating section 52 generates the DVD-Video files V0 such that image data sets S12 having higher evaluations are displayed longer, as illustrated in FIG. 11.

A representative image from among the image data sets S12 may be printed on the surface of the new DVD-R 102. At this time, the representative image may be selected from among image data sets S12 having high evaluations, based on the evaluations written in the meta data files X0. Alternatively, the unique ID's of the original DVD-R's 100 and 101, as well as the unique ID of the new DVD-R 102, may be printed on the surface of the new DVD-R 102.

In the present embodiment, a case has been described in which image data sets S12 read out from two DVD-R's 100 and 101 are recorded in a new DVD-R 102. There are cases in which representative images from among the image data sets S2 recorded in the DVD-R's 100 and 101 are printed on the surfaces thereof. In these cases, it is preferable that the representative images, which are printed on the original DVD-R's 100 and 101, are printed on the surface of the new DVD-R 102, as this would enable recognition regarding from which DVD-R's the new DVD-R 102 was generated. However, the area of the surface of DVD-R's is limited. Accordingly, it is difficult to print the representative images of the original DVD-R's 100 and 101, along with the representative image of the new DVD-R 102, on the surface of a single DVD-R.

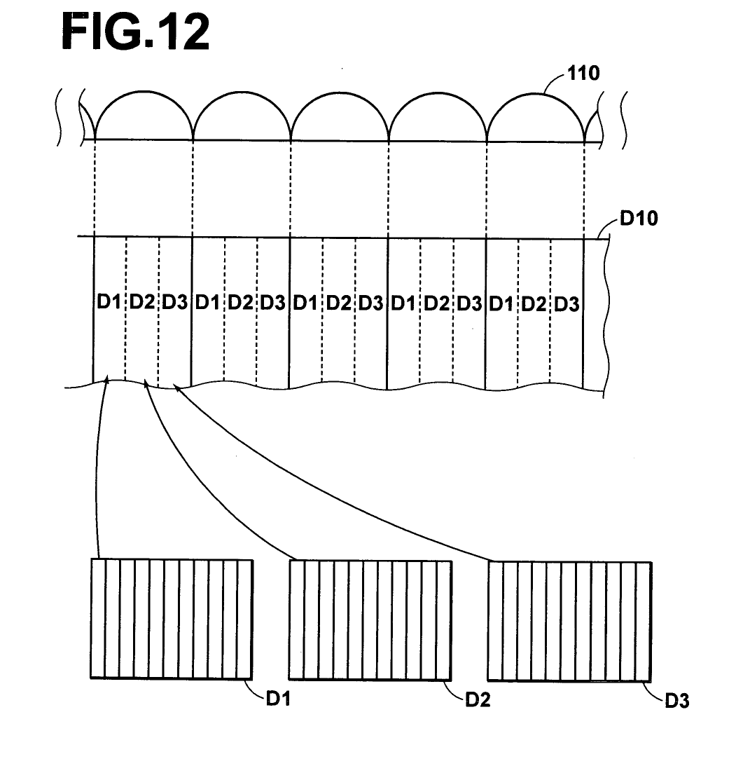

For this reason, in the present embodiment, the representative images of three DVD-R's are synthesized to form a lenticular image, and the lenticular image is printed on the new DVD-R 102. Hereinafter, lenticular synthesis will be described. FIG. 12 is a diagram for explaining lenticular synthesis of three images. Note that in FIG. 2, a lenticular sheet 110 is illustrated in cross section. In addition, lenticular synthesis of one of the representative images printed on the surfaces of the DVD-R's will be described. The lenticular synthesis employs image data sets S2 read out from the DVD-R's 100 and 101 that represent the representative images thereof, and an image data set S12 selected from among the image data sets S12 recorded in the new DVD-R 102.

First, representative images D1 and D2, which are printed on the DVD-R's 100 and 101, respectively, and a representative image D3, to be printed on the new DVD-R 102, are divided into strips having a third of the width of each cylindrical lens of the lenticular sheet 110 (lenticular pitch). Then, the representative images D1 through D3 are synthesized such that strips that correspond in position within the representative images D1 through D3 are arranged within the width of a single cylindrical lens, to obtain a synthesized representative image D10. The synthesized representative image is printed on the surface of the DVD-R 102, then the lenticular sheet 110 is pasted on the synthesized representative image D10, to complete printing of the representative image on the new DVD-R 102.

By printing the representative image on the new DVD-R 102 in this manner, it is possible to view the representative images of the original DVD-R's 100 and 101 and the representative image of the new DVD-R 102 as distinct images, by tilting the DVD-R 102. Accordingly, from which DVD-R's the new DVD-R 102 was generated can be known, by viewing the surface of the DVD-R 102.

Note that it is preferable that the representative images D1 through D3 are respectively selected from the folders sorted by years, and that strips, obtained by dividing the selected representative images D1 through D3, are arranged at positions that correspond to the order of years. Note that in the case that the representative images D1 through D3 are selected from a single folder, the strips may be arranged at positions that correspond to the photography dates thereof.

In the case that the reproduction order file is recorded in the DVD-R, the representative images D1 through D3 may be selected from among those listed in the reproduction order file. It is preferable that the strips, obtained by dividing the selected representative images D1 through D3 are arranged at positions that correspond to the reproduction order thereof.

In the case that the Index-Video files Vidx are recorded in the DVD-R, it is preferable that the representative images D1 through D3 are selected from among frame data sets that represent frame images that constitute the Index-Video files Vidx.

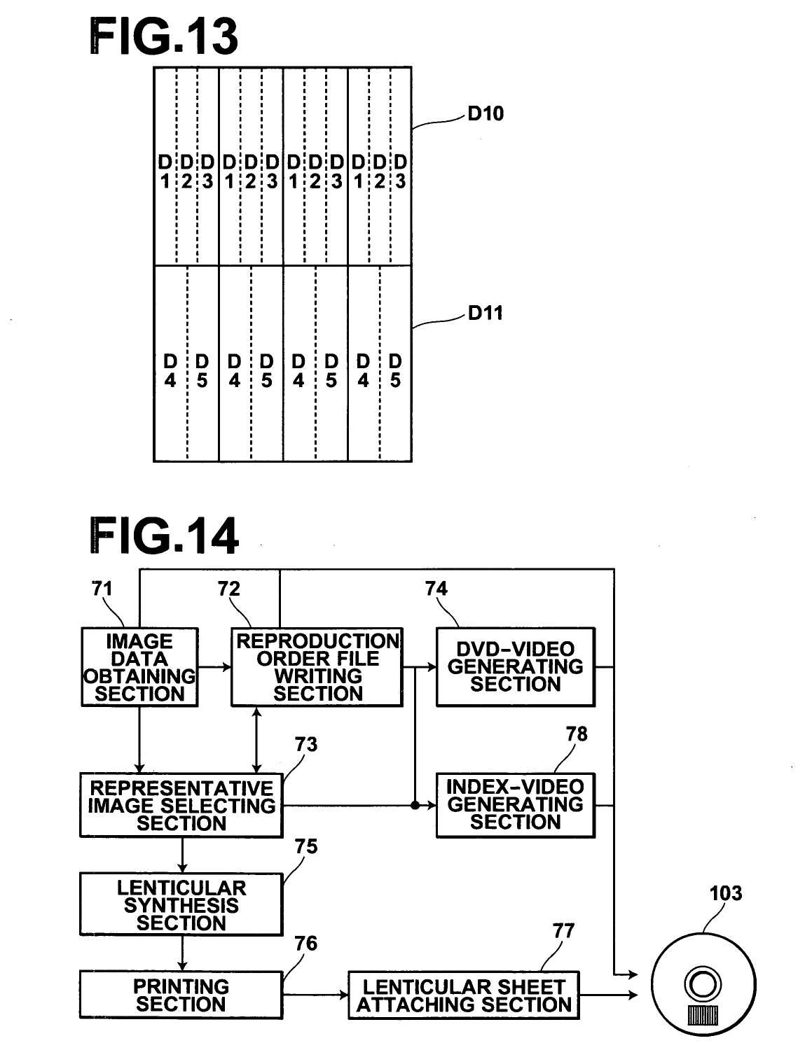

In the case that lenticular synthesis is performed, it is also possible to arrange strips of other images adjacent to the strips of the representative images in the longitudinal direction of the strips. Thereby, the number of images which are displayed can be increased. FIG. 13 illustrates an example of such an arrangement. Note that FIG. 13 illustrates a state in which a synthesized representative image D11, formed by synthesizing representative images D4 and D5, is arranged below a synthesized representative image D10, formed by synthesizing the representative images D1 through D3, in the longitudinal direction of the strips of the synthesized representative image D10. In this case, it is preferable that the strips, obtained by dividing each of the representative images D1 through D5, are arranged in positions that correspond to the order of photography dates thereof, such as D1, D4, D2, D5, and D3.

FIG. 14 is a schematic block diagram that illustrates the construction of the DVD generating section 52. Note that here, a DVD-R to be generated is denoted by reference number 103. As illustrated in FIG. 14, the DVD generating section 52 comprises: an image data obtaining section 71; a reproduction order file writing section 72; a representative image selecting section 73; a DVD-Video generating section 74; a lenticular synthesis section 75; a printing section 76; a lenticular sheet attaching section 77; and an Index-Video generating section 78. The reproduction order file writing section 72 writes reproduction order files. The representative image selecting section 73 selects representative images. The DVD-Video generating section 74 generates DVD-Video files V0. The lenticular synthesis section 75 synthesizes the representative images into lenticular images. The printing section 76 prints the synthesized representative images, obtained by lenticular synthesis of the representative images, onto the surface of the DVD-R 103 or onto a lenticular sheet. The lenticular sheet attaching section attaches a lenticular sheet onto the synthesized representative images. The Index-Video generating section 78 generates Index-Video files Vidx.

The operation of the DVD-generating section 52 illustrated in FIG. 14 will be described. First, the image data obtaining section 71 obtains image data sets. The obtained image data sets are grouped into predetermined folders, and recorded on the DVD-R 103 along with meta data thereof. The reproduction order file writing section 72 selects images to be included in DVD-Video files V0, generates reproduction order files that indicate reproduction orders and reproduction times, and records the reproduction order files on the DVD-R 103. The DVD-Video generating section 74 generates DVD-Video files V0 in slide show format, based on the reproduction order files, and records the DVD-Video files V0 in the DVD-R 103.

Meanwhile, the representative image selecting section 73 selects representative images, based on the meta data and the like. The Index-Video generating section 78 generates Index-Video files Vidx, based on the representative images selected by the representative image selecting section 73 and the contents of the reproduction order file generated by the reproduction order file writing section 72, and records the Index-Video files Vidx in the DVD-R 103.

The lenticular synthesis section 75 divides the plurality of representative images, selected by the representative image selecting section 73, into strips that correspond to a lenticular pitch. The representative images are synthesized into synthesized lenticular representative images in the order of the dates of photography, or in the reproduction orders thereof.

The printing section 76 prints the synthesized representative image, generated by the lenticular synthesis section 75, onto a lenticular sheet or onto the surface of the DVD-R 103.

The lenticualr sheet attaching section 77 attaches the lenticular sheet onto the surface of the DVD-R 103.

In this manner, the synthesized lenticular representative image is attached onto the surface of the DVD-R 103. Thereby, when enjoying photographic images reproduced as a slide show with a DVD player, a simple preview of the slide show is provided, by observing the DVD-R 103 in an inclined manner prior to loading it into the DVD player. Accordingly, a superior advantageous effect, of being able to recognize what kind of images, or images of what time period are included in the slide show of the DVD-R with one look, is obtained.

Note that the digital center 4 may keep records of the unique ID's of DVD-R's which have been delivered to users, for each user. The digital center 4 may also keep records of which DVD-R's the image data sets recorded in each DVD-R were read out from, for each unique ID. Thereby, in the case that a user loses a DVD-R, from which DVD-R's the image data sets that were recorded in the lost DVD-R were read out can be known, as long as they know the unique ID of the lost DVD-R. The user can report the unique ID of the lost DVD-R to the digital center 4 to obtain this information. Accordingly, in the case that the lost DVD-R was the first DVD-R generated for a user, the data cannot be reproduced. However, in the case that the lost DVD-R was generated by reading out image data sets which were recorded in other DVD-R's, the user is requested to mail the other DVD-R's to the digital center 4 or to transmit the image data sets that are recorded in the other DVD-R's to the digital center 4. Thereby, the lost DVD-R can be reproduced.

Losses of DVD-R's are reported to the digital center 4, and new DVD-R's are generated by employing the original DVD-R's, in which image data sets that were recorded in the lost DVD-R's are recorded. The digital center 4 may store all of the image data sets that are recorded in the original DVD-R's every time a loss is reported and generation of a new DVD-R is ordered. If the new DVD-R is generated after all of the image data sets, which are recorded in all of the original DVD-R's have been stored at the digital center, the new DVD-R will have recorded therein the same image data sets as the lost DVD-R. Accordingly, although this method is time consuming, losses of DVD-R's may be reported to the digital center 4, and the digital center 4 may generate DVD-R's identical to the lost DVD-R's.

When new DVD-R's are generated, image data sets recorded in original DVD-R's but not utilized in the new DVD-R's may be encrypted or assigned invisible properties and recorded in the new DVD-R's. In this case, the digital center 4 may keep records of data regarding such new DVD-R's.

DVD's have large capacities, and there is a possibility that next generation DVD's, such as Blu-ray, that have even greater capacities than presently available DVD's will be put into use. For this reason, it is possible to record encrypted or invisible image data sets not utilized in the new DVD-R's into the new DVD-R's, by appropriately varying the compression rates of image data sets, based on the aforementioned evaluations.

By adopting the above configuration, even if a user loses a DVD-R, the image data sets that were recorded in the lost DVD-R are also recorded in other DVD-R's. Therefore, the lost DVD-R can be reproduced by the digital center 4 decrypting or assigning visible properties to the encrypted or invisible image data sets in the other DVD-R's.

Note that it is possible to order generation of DVD-Video files V0 from image data sets recorded in DVD-R'sat DPE stores, by employing storefront terminal apparatuses. At this time, the storefront terminal apparatuses may be connected to a music storage server that stores music files correlated with their ID's. Users may obtain ID's of music files, by selecting background music desired to be included in slide shows with their cellular telephones or with their user terminals 20. During generation of the DVD-Video files V0, the ID's maybe input to the storefront terminal apparatuses. The storefront terminal apparatuses then may access the music storage server, download music files correlated with the input ID's, and generate the DVD-Video files.

1. An image recording apparatus, comprising:
image readout means, for reading out image data sets, which are recorded in a first recording medium identified by first unique identifying data, and which include the identifying data;
recording means, for recording the read out image data sets in a second recording medium identified by second unique identifying data; and
identifying data adding means, for adding the second unique identifying data to the image data sets in addition to the first unique identifying data, when recording the read out image data sets onto the second recording medium.

2. An image recording apparatus as defined in claim 1, wherein:
the unique identifying data is written in meta data; and
the identifying data adding means adds the identifying data as meta data.

3. An image recording apparatus as defined in claim 1, wherein:
additional data regarding the image data sets is recorded in the first recording medium as meta data; and
the recording means records date data, that represents the date when recording is performed, in addition to the additional data when recording the image data sets in the second recording medium.

4. An image recording apparatus as defined in claim 1, wherein:
the unique identifying data is included in file names; and
the identifying data adding means adds the unique identifying data to the file names.

5. An image recording apparatus as defined in claim 1, further comprising:
management means, for keeping track of which recording medium the image data sets are recorded in, by employing the identifying data.

6. An image recording method, comprising the steps of:
reading out image data sets, which are recorded in a first recording medium identified by first unique identifying data, and which include the identifying data;
adding second unique identifying data to the image data sets in addition to the first unique identifying data, when recording the read out image data sets onto a second recording medium identified by the second unique identifying data; and
recording the image data sets, having the identifying data of the second recording medium added thereto, in the second recording medium.

7. An image recording method as defined in claim 6, wherein:
the unique identifying data is written in meta data; and
the identifying data is added as meta data.

8. An image recording method as defined in claim 6, wherein:
additional data regarding the image data sets is recorded in the first recording medium as meta data; and
date data, that represents the date when recording is performed, is recorded in addition to the additional data, when recording the image data sets in the second recording medium.

9. An image recording method as defined in claim 6, wherein:
the unique identifying data is included in file names; and
the unique identifying data is added to the file names.

10. An image recording method as defined in claim 3, wherein:
the identifying data are employed to keep track of which recording medium the image data sets are recorded in.

11. A program for causing a computer to execute an image recording method, the program comprising the procedures of:
reading out image data sets, which are recorded in a first recording medium identified by first unique identifying data, and which include the identifying data;
adding second unique identifying data to the image data sets in addition to the first unique identifying data, when recording the read out image data sets onto a second recording medium identified by the second unique identifying data; and
recording the image data sets, having the identifying data of the second recording medium added thereto, in the second recording medium.

12. A program as defined in claim 11, wherein:
the unique identifying data is written in meta data; and
the identifying data is added as meta data.

13. A program as defined in claim 11, wherein:
additional data regarding the image data sets is recorded in the first recording medium as meta data; and
date data, that represents the date when recording is performed, is recorded in addition to the additional data, when recording the image data sets in the second recording medium.

14. A program as defined in claim 11, wherein:
the unique identifying data is included in file names; and
the unique identifying data is added to the file names.

15. A program as defined in claim 11, wherein:
the identifying data are employed to keep track of which recording medium the image data sets are recorded in.

16. A computer readable medium, having the program defined in claim 11 recorded therein.

17. A computer readable medium, having the program defined in claim 12 recorded therein.

18. A computer readable medium, having the program defined in claim 13 recorded therein.

19. A computer readable medium, having the program defined in claim 14 recorded therein.

20. A computer readable medium, having the program defined in claim 15 recorded therein.
